(19) United States
(12) Patent Application Publication
(10) Pub. No.: US 2025/0001498 A1
(43) Pub. Date: Jan. 2, 2025

(54) PREPARATION METHOD OF RARE EARTH PERMANENT MAGNETIC MATERIAL

(71) Applicant: NINGBO INSTITUTE OF MATERIALS TECHNOLOGY AND ENGINEERING, CHINESE ACADEMY OF SCIENCES, Ningbo, Zhejiang (CN)

(72) Inventors: Bo Zhou, Ningbo, Zhejiang (CN); Lei Liu, Ningbo, Zhejiang (CN); Yingli Sun, Ningbo, Zhejiang (CN); Yong Ding, Ningbo, Zhejiang (CN); Aru Yan, Ningbo, Zhejiang (CN)

(21) Appl. No.: 18/274,460

(22) PCT Filed: Mar. 13, 2023
(86) PCT No.: PCT/CN2023/080981

§ 371 Date: Jul. 26, 2023

(30) Foreign Application Priority Data
Mar. 9, 2023 (CN) 202310221428.8

(51) Int. Cl. B22F 3/24; B22F 3/16; B22F 9/02; B22F 9/04; C22C 1/02; C22C 19/07; C22C 30/02; C22C 33/04; C22C 38/00; C22C 38/06; C22C 38/10; C22C 38/14; C22C 38/16; H01F 1/059

(52) U.S. Cl. CPC B22F 3/24; B22F 3/16; B22F 9/023; B22F 9/04; C22C 1/02; C22C 19/07; C22C 30/02; C22C 33/04; C22C 38/005; C22C 38/06; C22C 38/10; C22C 38/14; C22C 38/16; H01F 1/059; B22F 2003/241; B22F 2003/248; B22F 2009/044; B22F 2201/016; B22F 2201/02; B22F 2201/11; B22F 2202/03; B22F 2202/05; B22F 2301/155; B22F 2301/355; B22F 2301/40; B22F 2304/10; B22F 2998/10; B22F 2999/00; C22C 2202/02

(57) ABSTRACT

A preparation method of a rare earth permanent magnetic material comprises one or more times of cryogenic treatment and tempering treatment. When the preparation method comprises one time of cryogenic treatment and tempering treatment, the cryogenic treatment is performed between sintering treatment and the tempering treatment, or is performed after the tempering treatment. When the preparation method comprises two or more times of cryogenic treatment and tempering treatment, at least one time of cryogenic treatment is performed between sintering treatment and the tempering treatment, and at least one time of cryogenic treatment is performed after the tempering treatment. The preparation method can refine and homogenize the structure and realize quick and convenient treatment, and can effectively improve the mechanical performance of the rare earth permanent magnetic material and maintain good magnetic performance.

### TECHNICAL FIELD

The invention belongs to the technical field of magnetic materials, and relates to a preparation method of a rare earth permanent magnetic material.

### DESCRIPTION OF RELATED ART

Rare earth permanent magnetic materials are widely used in many fields due to their good magnetic performance. However, like many intermetallic compounds, rare earth permanent magnetic materials have high brittleness at room temperature, which makes it difficult to realize mechanical machining of the rare earth permanent magnetic materials; magnets are prone to cracking and edge breakage in use, resulting in a negative influence on the stability of permanent magnetic devices, thus limiting the application of rare earth permanent magnetic materials to precise instruments and occasions with high requirements for shock resistance and vibration resistance.

At present, there has been study on the improvement of mechanical performance by surface modification, element doping, oxide addition, or other methods. However, although these methods can improve the mechanical performance, they may lead to a drastic reduction of magnetic performance. Existing methods for improving the mechanical performance of rare earth permanent magnetic materials will sacrifice the magnetic performance, and are complex in process and high in cost, making it hard to apply these methods to actual production.

Cryogenic treatment refers to treating workpieces at a temperature below −130° C. with liquid nitrogen as a refrigerant, and can remarkably improve the mechanical performance of ferrous metals and non-ferrous metals. However, the use of cryogenic treatment for improving the mechanical performance of rare earth permanent magnetic materials has not been reported.

### BRIEF SUMMARY OF THE INVENTION

To solve the problem that rare earth permanent magnetic materials have high brittleness at room temperature and existing methods for improving the mechanical performance of rare earth permanent magnetic materials will sacrifice the magnetic performance, the invention provides a method for improving the mechanical performance of rare earth permanent magnetic materials, which can effectively improve the mechanical performance of rare earth permanent magnetic materials and maintain the good magnetic performance of the rare earth permanent magnetic materials.

The invention is implemented through the following technical solution:

A method for preparing a rare earth permanent magnetic material comprises one or more times of cryogenic treatment and tempering treatment.

Preferably, the preparation method comprises one time of cryogenic treatment and tempering treatment, wherein the cryogenic treatment is performed between sintering treatment and the tempering treatment, or the cryogenic treatment is performed after the tempering treatment.

Preferably, the preparation method comprises two or more times of cryogenic treatment and tempering treatment, wherein at least one time of cryogenic treatment is performed between sintering treatment and the tempering treatment, and at least one time of cryogenic treatment is performed after the tempering treatment.

Preferably, the preparation method comprises two times of cryogenic treatment and tempering treatment, wherein primary cryogenic treatment is performed after sintering treatment, then the tempering treatment is performed, and then, secondary cryogenic treatment is performed.

Preferably, the preparation method comprises three times of cryogenic treatment and tempering treatment.

Preferably, primary cryogenic treatment is performed after sintering treatment, then the tempering treatment is performed, then secondary cryogenic treatment is performed, and then, ternary cryogenic treatment is performed;

Or, primary cryogenic treatment is performed after sintering treatment, then secondary cryogenic treatment is performed, then the tempering treatment is performed, and then, ternary cryogenic treatment is performed.

Preferably, the rare earth permanent magnetic material comprises one of an R₂Fe₁₄B series rare earth permanent magnetic material alloy, a SmCo₅ series rare earth permanent magnetic material alloy, a Sm₂Co₁₇ series rare earth permanent magnetic material alloy, a Sm₂Fe₁₇Nₓ series rare earth permanent magnetic material alloy, and a 1:12 type rare earth permanent magnetic material alloy.

Preferably, the preparation method comprises: raw material preparation, melting, pulverizing, oriented green compacting, sintering treatment, cryogenic treatment, and tempering treatment;

or, the preparation method comprises: raw material preparation, melting, pulverizing, oriented green compacting, sintering treatment, tempering treatment, and cryogenic treatment.

Preferably, the preparation method comprises: raw material preparation, melting, pulverizing, oriented green compacting, sintering treatment, primary cryogenic treatment, tempering treatment, and secondary cryogenic treatment.

Preferably, the preparation method comprises: raw material preparation, melting, pulverizing, oriented green compacting, sintering treatment, primary cryogenic treatment, tempering treatment, secondary cryogenic treatment, and ternary cryogenic treatment;

Or, the preparation method comprises: raw material preparation, melting, pulverizing, oriented green compacting, sintering treatment, primary cryogenic treatment, secondary cryogenic treatment, tempering treatment, and ternary cryogenic treatment.

Preferably, the step of cryogenic treatment comprises: placing a green body in a cryogenic treatment system, performing cryogenic treatment when the temperature is decreased to a cryogenic treatment temperature, and then taking the green body out of the cryogenic treatment system;

Or, the step of cryogenic treatment comprises: directly placing a green body in liquid nitrogen for cryogenic treatment, and then taking the green body out of the liquid nitrogen.

Preferably, the cryogenic treatment temperature is lower than or equal to −130° C., and/or the cryogenic treatment time is 1-500 min.

Preferably, the cryogenic treatment temperature is lower than or equal to −160° C., and/or the cryogenic treatment time is 10-400 min.

Preferably, the cryogenic treatment temperature is lower than or equal to −190° C., and/or the cryogenic treatment time is 20-300 min.

Preferably, the tempering treatment is one of tempering diffusion treatment, aging treatment and nitrogen treatment.

Preferably, the tempering diffusion treatment comprises: performing primary tempering at 800-950° C. for 2-6 h, and then decreasing the temperature to 400-650° C. at a rate of 0.3-1.3° C./min to perform secondary tempering for 2-6 h;

The aging treatment comprises: maintaining a green body at 800-950° C. for 10-25 h, then decreasing the temperature to 400-550° C. at a rate of 0.3-1.3° C./min, and maintaining the green body at 400-550° C. for 2-12 h;

The nitrogen treatment comprises: maintaining the green body at 400-650° C. for 1-20 h under a nitrogen and/or ammonia atmosphere.

The invention also provides a rare earth permanent magnetic material, which is prepared by the preparation method mentioned above.

Compared with the prior art, the invention has the following beneficial effects:
1. In the invention, cryogenic treatment is performed once after sintering, the size of a green body is reduced with the decrease of temperature, and structural defects such as internal stress and dislocation are generated inside, which promotes precipitation and growth of a precipitated phase during the tempering process, and a uniform and complete structure and good magnetic performance can be obtained;
2. In the invention, secondary cryogenic treatment is performed after tempering treatment, which improves the bending strength of rare earth permanent materials; and compared with other methods for improving mechanical performance such as surface modification, the method provided by the invention is simpler, more effective, low in cost, high in operability and suitable for mass production;
3. The preparation method of a rare earth permanent magnetic material of the invention comprises two or more times of cryogenic treatment and tempering treatment, and at least one time of cryogenic treatment is performed between sintering treatment and tempering treatment, and at least one time of cryogenic treatment is performed after the tempering treatment, so the bending strength and magnetic performance of the material are improved;
4. Compared with methods such as element doping and oxide addition, the method for improving the mechanical performance of rare earth permanent magnetic materials provided by the invention does not introduce a non-magnetic phase, and thus will not reduce the magnetic performance.

### BRIEF DESCRIPTION OF THE SEVERAL VIEWS OF THE DRAWINGS

FIG. 1 is a schematic diagram of the size, orientation and stress direction of samples for a three point bending test;

FIG. 2 illustrates three-point bending curves of a samarium-cobalt permanent magnet prepared in Embodiment 1 and a samarium-cobalt permanent magnet prepared in Comparative Example 1;

FIG. 3 illustrates demagnetization curves of the samarium-cobalt permanent magnet prepared in Embodiment 1 and the samarium-cobalt permanent magnet prepared in Comparative Example 1.

### DETAILED DESCRIPTION OF THE INVENTION

Embodiments of a preparation method of a rare earth permanent magnetic material provided by the invention will be described in detail below. These embodiments are merely illustrative, and the contents disclosed by the invention are not limited to the following embodiments.

A preparation method of a rare earth permanent magnetic material comprises one or more times of cryogenic treatment and tempering treatment.

In some embodiments of the invention, the preparation method comprises one time of cryogenic treatment and tempering treatment, wherein the cryogenic treatment is performed between sintering treatment and the tempering treatment, or the cryogenic treatment is performed after the tempering treatment. The preparation method comprises: performing cryogenic treatment after sintering treatment, and then performing tempering treatment. Or, the preparation method comprises: performing tempering treatment after sintering treatment, and then performing cryogenic treatment. Preferably, the preparation method comprises: performing tempering treatment after sintering treatment, and then performing cryogenic treatment. When the preparation method comprises one time of cryogenic treatment, the cryogenic treatment is performed after tempering treatment to improve the bending strength and magnetic performance of the rare earth magnetic material.

In some embodiments of the invention, the preparation method comprises two or more times of cryogenic treatment and tempering treatment, wherein at least one time of cryogenic treatment is performed between sintering treatment and the tempering treatment, and at least one time of cryogenic treatment is performed after the tempering treatment.

In some embodiments of the invention, preferably, the preparation method comprises two times of cryogenic treatment and tempering treatment. Specifically, primary cryogenic treatment is performed after sintering treatment, then the tempering treatment is performed, and then, secondary cryogenic treatment is performed. Through two times of cryogenic treatment, the rare earth permanent magnetic material has better bending strength and magnetic performance.

In some embodiments of the invention, the preparation method comprises three times of cryogenic treatment and tempering treatment. Preferably, the preparation method comprises: performing primary cryogenic treatment after sintering treatment, then performing tempering treatment, then performing secondary cryogenic treatment, and then performing ternary cryogenic treatment. Or, the preparation method comprises: performing primary cryogenic treatment after sintering treatment, then performing secondary cryogenic treatment, then performing tempering treatment, and then performing ternary cryogenic treatment.

In some embodiments of the invention, the cryogenic treatment temperature is lower than or equal to −130° C.; preferably, the cryogenic treatment temperature is lower than or equal to −160° C.; and further preferably, the cryogenic treatment temperature is lower than or equal to −190° C.

In some embodiments of the invention, the cryogenic treatment time is 1-500 min; preferably, the cryogenic treatment time is 10-400 min; and further preferably, the cryogenic treatment time is 20-300 min.

In some embodiments of the invention, the step of cryogenic treatment comprises: placing a green body in a cryogenic treatment system, performing cryogenic treatment when the temperature is decreased to the cryogenic treatment temperature, and then taking the green body out of the cryogenic treatment system. After the temperature of the green body taken out of the cryogenic treatment system is increased to room temperature, the next step is performed.

In some embodiments of the invention, the step of cryogenic treatment comprises: directly placing a green body in liquid nitrogen for cryogenic treatment, and then taking the green body out of the liquid nitrogen. After the temperature of the green body taken out of the liquid nitrogen is increased to room temperature, the next step is performed.

In some embodiments of the invention, the tempering treatment temperature T2 is higher than or equal to 200° C.; and further preferably, the tempering treatment temperature T2 is higher than or equal to 400° C.

In some embodiments of the invention, the tempering treatment comprises: treating the green body at 800-950° C. for 2-25 h, and then decreasing the temperature to 400-650° C. to treat the green body for 2-15 h.

In some embodiments of the invention, the rare earth permanent magnetic material comprises, but is not limited to, one of an R₂Fe₁₄B series (R is one or more of La, Ce, Pr, Nd, Gd, Tb, Dy, Ho and Y) rare earth permanent magnetic material alloy, a SmCo₅ series rare earth permanent magnetic material alloy, a Sm₂Co₁₇ series rare earth permanent magnetic material alloy, a Sm₂Fe₁₇Nₓ series rare earth permanent magnetic material alloy, and a 1:12 type rare earth permanent magnetic material alloy, and the rare earth permanent magnetic material is powdery or blocky.

When the rare earth permanent magnetic material is the R₂Fe₁₄B series rare earth permanent magnetic material alloy, the tempering treatment is tempering diffusion treatment; when the rare earth permanent magnetic material is the SmCo₅ series rare earth permanent magnetic material alloy, the Sm₂Co₁₇ series rare earth permanent magnetic material alloy and the 1:12 type rare earth permanent magnetic material alloy, the tempering treatment is aging treatment; and when the rare earth permanent magnetic material is the Sm₂Fe₁₇Nₓ series rare earth permanent magnetic material alloy, the tempering treatment is nitrogen treatment.

The tempering diffusion treatment comprises: performing primary tempering at 800-950° C. for 2-6 h, and then decreasing the temperature to 400-650° C. at a rate of 0.3-1.3° C./min to perform secondary tempering for 2-6 h.

The aging treatment comprises: maintaining the green body at 800-950° C. for 10-25 h, then decreasing the temperature to 400-550° C. at a rate of 0.3-1.3° C./min, and maintaining the green body at 400˜550° C. for 2-12 h.

The nitrogen treatment comprises: maintaining the green body at 400-650° C. for 1-20 h under a nitrogen atmosphere, an ammonia atmosphere, or a nitrogen and ammonia hybrid atmosphere.

In some embodiments of the invention, before sintering treatment, the preparation method further comprises raw material preparation, melting, pulverizing, and oriented green compacting.

In some embodiments of the invention, the preparation method comprises raw material preparation, melting, pulverizing, oriented green compacting, sintering treatment, cryogenic treatment, and tempering treatment.

In some embodiments of the invention, the preparation method comprises: raw material preparation, melting, pulverizing, oriented green compacting, sintering treatment, tempering treatment, and cryogenic treatment.

In some embodiments of the invention, the preparation method comprises: raw material preparation, melting, pulverizing, oriented green compacting, sintering treatment, primary cryogenic treatment, tempering treatment, and secondary cryogenic treatment.

In some embodiments of the invention, the preparation method comprises: raw material preparation, melting, pulverizing, oriented green compacting, sintering treatment, primary cryogenic treatment, tempering treatment, secondary cryogenic treatment, and ternary cryogenic treatment.

In some embodiments of the invention, the preparation method comprises: raw material preparation, melting, pulverizing, oriented green compacting, sintering treatment, primary cryogenic treatment, secondary cryogenic treatment, tempering treatment, and ternary cryogenic treatment.

The invention has no limitation to the steps of raw material preparation, melting, pulverizing, oriented green compacting and sintering treatment, and common process steps in the art can be adopted.

The specific steps of raw material preparation, melting, pulverizing, oriented green compacting and sintering treatment are illustrated below:

Raw material preparation: raw materials are weighed and prepared according to the stoichiometric ratio of the molecular formula of the rare earth permanent magnetic material.

Melting: the prepared raw materials are placed in a vacuum melting furnace to be melted, wherein the melting temperature is 1200-1800° C.; when the raw materials are melted into a uniform alloy solution, the uniform alloy solution is poured into a cooling copper mold to obtain an alloy ingot.

Pulverizing: the alloy ingot is crushed into 100-500 μm powder through a machine, and then the 100-500 μm powder is ground into powder with a mean grain size of 2-6 μm through jet milling.

Oriented green compacting: oriented formation is performed under a 1-5 T magnetic field, the pressure is held at 150-200 MPa for 10-40 s through a cold isostatic press after packaging, and green compacting is performed to obtain a green body.

Sintering treatment: the green body is sintered at 1150-1250° C. for 1-5 h under the protection of an inert gas, is subjected to solid solution treatment at 1130-1210° C. for 1-5 h under the protection of the inert gas, and is then cooled to room temperature; or, sintering treatment: the green body is sintered at 1020-1100° C. for 2-8 h under a vacuum condition.

The technical solutions of the invention will be further described and explained below with reference to specific embodiments and drawings. It should be understood that the specific embodiments in the following description are merely used to help understand the invention rather than limiting the invention. Drawings used in this specification are merely for better describing the contents of the invention, and have no limitation to the protection scope of the invention. Unless otherwise specifically stated, raw materials used in the embodiments of the invention are all common raw materials in the art, and methods adopted in the embodiments of the invention are all conventional methods in the art.

### Embodiment 1

Raw material preparation: raw materials of a Sm₂Co₇ samarium-cobalt permanent magnet material in this embodiment included, by weight, 24.75% of Sm, 49.70% of Co, 18.97% of Fe, 4.37% of Cu, and the balance Zr, wherein the purity of Sm, Co and Cu was higher than or equal to 99.9%, and the purity of Fe and Zr was higher than or equal to 99.5%;

Melting: the prepared raw materials were melted through a vacuum high-frequency induction furnace, wherein high-purity argon was injected into the vacuum high-frequency induction furnace, and the melting temperature was 1500° C.; after the raw materials were melted into a uniform alloy solution, the alloy solution was poured into a cooling copper mold to obtain an alloy ingot;

Pulverizing: the ingot was crushed into 100-300 μm powder through a machine, and then the 100-300 μm powder was ground into powder with a mean gain size of 4.6 μm through a jet milling process;

Oriented green compacting: oriented formation was performed under a 2 T magnetic field, the pressure was held at 170 MPa for 20 s through a cold isostatic press after packaging, and green compacting was performed to obtain a green body;

Sintering and solid solution: the green body was sintered at 1206° C. for 2 h under the protection of the argon, subjected to solid solution treatment at 1190° C. for 2 h under the protection of the argon, and then air-cooled to room temperature;

Primary cryogenic treatment: the green body was directly placed in liquid nitrogen to be subjected to cryogenic treatment for 0.5 h, and then was taken out of the liquid nitrogen and placed in air to be heated up naturally;

Aging treatment: the green body was subjected to aging treatment at 840° C. for 12 h under the protection of the argon, then cooled to 400° C. at a rate of 0.5° C./min, maintained at this temperature for 3 h, and then air-cooled to room temperature to obtain a magnet;

Secondary cryogenic treatment: the green body was directly placed in liquid nitrogen to be subjected to cryogenic treatment for 1 h, and then was taken out of the liquid nitrogen and placed in air to be heated up naturally.

### Embodiment 2

Raw material preparation: raw materials of a Sm₂Co₇ samarium-cobalt permanent magnet material in this embodiment included, by weight, 25.76% of Sm, 57.23% of Co, 6.72% of Fe, 7.23% of Cu, and the balance Zr, wherein the purity of Sm, Co and Cu was higher than or equal to 99.9%, and the purity of Fe and Zr was higher than or equal to 99.5%;

Melting: the prepared raw materials were melted through a vacuum high-frequency induction furnace, wherein high-purity argon was injected into the vacuum high-frequency induction furnace, and the melting temperature was 1500° C.; after the raw materials were melted into a uniform alloy solution, the alloy solution was poured into a cooling copper mold to obtain an alloy ingot;

Pulverizing: the ingot was crushed into 100-300 μm powder through a machine, and then the 100-300 μm powder was ground into powder with a mean gain size of 4.5 μm through a jet milling process;

Oriented green compacting: oriented formation was performed under a 2 T magnetic field, the pressure was held at 160 MPa for 25 s through a cold isostatic press after packaging, and green compacting was performed to obtain a green body;

Sintering and solid solution: the green body was sintered at 1233° C. for 2 h under the protection of the argon, subjected to solid solution treatment at 1180° C. for 2 h under the protection of the argon, and then air-cooled to room temperature;

Primary cryogenic treatment: the green body was directly placed in liquid nitrogen to be subjected to cryogenic treatment for 0.5 h, and then was taken out of the liquid nitrogen and placed in air to be heated up naturally;

Aging treatment: the green body was subjected to aging treatment at 840° C. for 20 h under the protection of the argon, then cooled to 400° C. at a rate of 0.5° C./min, maintained at this temperature for 10 h, and then air-cooled to room temperature to obtain a magnet;

Secondary cryogenic treatment: the green body was directly placed in liquid nitrogen to be subjected to cryogenic treatment for 1 h, and then was taken out of the liquid nitrogen and placed in air to be heated up naturally.

### Embodiment 3

Raw material preparation: raw materials of a Sm₂Co₁₇ samarium-cobalt permanent magnet material in this embodiment included, by weight, 24.75% of Sm, 49.70% of Co, 18.97% of Fe, 4.37% of Cu, and the balance Zr, wherein the purity of Sm, Co and Cu was higher than or equal to 99.9%, and the purity of Fe and Zr was higher than or equal to 99.5%;

Melting: the prepared raw materials were melted through a vacuum high-frequency induction furnace, wherein high-purity argon was injected into the vacuum high-frequency induction furnace, and the melting temperature was 1500° C.; after the raw materials were melted into a uniform alloy solution, the alloy solution was poured into a cooling copper mold to obtain an alloy ingot;

Pulverizing: the ingot was crushed into 100-300 μm powder through a machine, and then the 100-300 μm powder was ground into powder with a mean gain size of 4.6 μm through a jet milling process;

Oriented green compacting: oriented formation was performed under a 2 T magnetic field, the pressure was held at 170 MPa for 20 s through a cold isostatic press after packaging, and green compacting was performed to obtain a green body;

Sintering and solid solution: the green body was sintered at 1206° C. for 2 h under the protection of the argon, subjected to solid solution treatment at 1190° C. for 2 h under the protection of the argon, and then air-cooled to room temperature;

Aging treatment: the green body was subjected to aging treatment at 840° C. for 12 h under the protection of the argon, then cooled to 400° C. at a rate of 0.5° C./min, maintained at this temperature for 3 h, and then air-cooled to room temperature to obtain a magnet;

Cryogenic treatment: the green body was directly placed in liquid nitrogen to be subjected to cryogenic treatment for 1 h, and then was taken out of the liquid nitrogen and placed in air to be heated up naturally.

### Embodiment 4

Raw material preparation: raw materials of a Sm₂Co₇ samarium-cobalt permanent magnet material in this embodiment included, by weight, 24.75% of Sm, 49.70% of Co, 18.97% of Fe, 4.37% of Cu, and the balance Zr, wherein the purity of Sm, Co and Cu was higher than or equal to 99.9%, and the purity of Fe and Zr was higher than or equal to 99.5%;

Melting: the prepared raw materials were melted through a vacuum high-frequency induction furnace, wherein high-purity argon was injected into the vacuum high-frequency induction furnace, and the melting temperature was 1500° C.; after the raw materials were melted into a uniform alloy solution, the alloy solution was poured into a cooling copper mold to obtain an alloy ingot;

Pulverizing: the ingot was crushed into 100-300 μm powder through a machine, and then the 100-300 μm powder was ground into powder with a mean gain size of 4.7 μm through a jet milling process;

Oriented green compacting: oriented formation was performed under a 2 T magnetic field, the pressure was held at 170 MPa for 20 s through a cold isostatic press after packaging, and green compacting was performed to obtain a green body;

Sintering and solid solution: the green body was sintered at 1206° C. for 2 h under the protection of the argon, subjected to solid solution treatment at 1190° C. for 2 h under the protection of the argon, and then air-cooled to room temperature;

Primary cryogenic treatment: the green body was directly placed in liquid nitrogen to be subjected to cryogenic treatment for 0.5 h, and then was taken out of the liquid nitrogen and placed in air to be heated up naturally;

Aging treatment: the green body was subjected to aging treatment at 840° C. for 12 h under the protection of the argon, then cooled to 400° C. at a rate of 0.5° C./min, maintained at this temperature for 3 h, and then air-cooled to room temperature to obtain a magnet;

Secondary cryogenic treatment: the green body was directly placed in liquid nitrogen to be subjected to cryogenic treatment for 0.5 h, and then was taken out of the liquid nitrogen and placed in air to be heated up naturally;

Ternary cryogenic treatment: the green body was directly placed in liquid nitrogen to be subjected to cryogenic treatment for 1 h, and then was taken out of the liquid nitrogen and placed in air to be heated up naturally.

### Embodiment 5

Raw material preparation: raw materials of a Sm₂Co₁₇ samarium-cobalt permanent magnet material in this embodiment included, by weight, 24.75% of Sm, 49.70% of Co, 18.97% of Fe, 4.37% of Cu, and the balance Zr, wherein the purity of Sm, Co and Cu was higher than or equal to 99.9%, and the purity of Fe and Zr was higher than or equal to 99.5%;

Melting: the prepared raw materials were melted through a vacuum high-frequency induction furnace, wherein high-purity argon was injected into the vacuum high-frequency induction furnace, and the melting temperature was 1500° C.; after the raw materials were melted into a uniform alloy solution, the alloy solution was poured into a cooling copper mold to obtain an alloy ingot;

Pulverizing: the ingot was crushed into 100-300 μm powder through a machine, and then the 100-300 μm powder was ground into powder with a mean gain size of 4.6 μm through a jet milling process;

Oriented green compacting: oriented formation was performed under a 2 T magnetic field, the pressure was held at 170 MPa for 20 s through a cold isostatic press after packaging, and green compacting was performed to obtain a green body;

Sintering and solid solution: the green body was sintered at 1206° C. for 2 h under the protection of the argon, subjected to solid solution treatment at 1190° C. for 2 h under the protection of the argon, and then air-cooled to room temperature;

Primary cryogenic treatment: the green body was placed in a cryogenic treatment system, cooled to −190° C. at a rate of 5° C./min, maintained at this temperature for 0.5 h, and then taken out of the cryogenic treatment system and placed in air to be heated up naturally;

Aging treatment: the green body was subjected to aging treatment at 840° C. for 12 h under the protection of the argon, then cooled to 400° C. at a rate of 0.5° C./min, maintained at this temperature for 3 h, and then air-cooled to room temperature to obtain a magnet;

Secondary cryogenic treatment: the green body was placed in the cryogenic treatment system, cooled to −190° C. at a rate of 10° C./min, maintained at this temperature for 0.5 h, and then taken out of the cryogenic treatment system and placed in air to be heated up naturally.

### Embodiment 6

Raw material preparation: raw materials of a Sm₂Co₁₇ samarium-cobalt permanent magnet material in this embodiment included, by weight, 24.75% of Sm, 49.70% of Co, 18.97% of Fe, 4.37% of Cu, and the balance Zr, wherein the purity of Sm, Co and Cu was higher than or equal to 99.9%, and the purity of Fe and Zr was higher than or equal to 99.5%;

Melting: the prepared raw materials were melted through a vacuum high-frequency induction furnace, wherein high-purity argon was injected into the vacuum high-frequency induction furnace, and the melting temperature was 1500° C.; after the raw materials were melted into a uniform alloy solution, the alloy solution was poured into a cooling copper mold to obtain an alloy ingot;

Pulverizing: the ingot was crushed into 100-300 μm powder through a machine, and then the 100-300 μm powder was ground into powder with a mean gain size of 4.6 μm through a jet milling process;

Oriented green compacting: oriented formation was performed under a 2 T magnetic field, the pressure was held at 170 MPa for 20 s through a cold isostatic press after packaging, and green compacting was performed to obtain a green body;

Sintering and solid solution: the green body was sintered at 1206° C. for 2 h under the protection of the argon, subjected to solid solution treatment at 1190° C. for 2 h under the protection of the argon, and then air-cooled to room temperature;

Primary cryogenic treatment: the green body was placed in a cryogenic treatment system, cooled to −190° C. at a rate of 10° C./min, maintained at this temperature for 0.5 h, and then taken out of the cryogenic treatment system and placed in air to be heated up naturally;

Aging treatment: the green body was subjected to aging treatment at 840° C. for 12 h under the protection of the argon, then cooled to 400° C. at a rate of 0.5° C./min, maintained at this temperature for 3 h, and then air-cooled to room temperature to obtain a magnet;

Secondary cryogenic treatment: the green body was directly placed in liquid nitrogen to be subjected to cryogenic treatment for 0.5 h, and then was taken out of the liquid nitrogen and placed in air to be heated up naturally;

Ternary cryogenic treatment: the green body was placed in the cryogenic treatment system, cooled to −194° C. at a rate of 10° C./min, maintained at this temperature for 0.5 h, and then taken out of the cryogenic treatment system and placed in air to be heated up naturally.

### Embodiment 7

The preparation method of a samarium-cobalt permanent magnet in Embodiment 7 differs from the preparation method in Embodiment 1 in that secondary cryogenic treatment was not performed after aging treatment of the green body, and is identical with Embodiment 1 in other aspects.

### Embodiment 8

A neodymium-iron-boron alloy adopted in this embodiment was (PrNd)₃₂(CoCuAlZr)_{0.2}FebalB, and a preparation process including vacuum quick-setting melting—hydrogen crushing—pulverizing by jet milling—oriented formation under a magnetic field—cold isostatic pressing—primary cryogenic treatment—tempering treatment—secondary cryogenic treatment was adopted. Wherein, the mean grain size of powder obtained through jet milling was 2.18 μm, a green body was sintered at 1060° C. for 5 h under a vacuum condition, and then the green body was directly placed in liquid nitrogen, taken out of the liquid nitrogen 0.5 h later to be subjected to primary cryogenic treatment, then placed in air to be heated up naturally, then maintained at 900° C. and 480° C. for 3 h for tempering treatment (the cooling rate from 900° C. to 480° C. was 0.5° C./min), and then directly placed in liquid nitrogen, taken out 1 h later, and placed in air to be heated up naturally for secondary cryogenic treatment.

### Embodiment 9

The preparation method of a neodymium-iron-boron magnet in Embodiment 9 differs from the preparation method in Embodiment 8 in that primary cryogenic treatment was not performed after sintering of the green body, and is identical with Embodiment 8 in other aspects.

### Embodiment 10

The preparation method of a neodymium-iron-boron magnet in Embodiment 10 differs from the preparation method in Embodiment 8 in that secondary cryogenic treatment was not performed after tempering treatment of the green body, and is identical with Embodiment 8 in other aspects.

### Comparative Example 1

The preparation method of a samarium-cobalt permanent magnet in Comparative Example 1 differs from the preparation method in Embodiment 1 in that primary cryogenic treatment was not performed after sintering and solid solution of the green body and secondary cryogenic treatment was not performed after ageing treatment, and is identical with Embodiment 1 in other aspects.

### Comparative Example 2

The preparation method of a samarium-cobalt permanent magnet in Comparative Example 2 differs from the preparation method in Embodiment 2 in that primary cryogenic treatment was not performed after sintering and solid solution of the green body and secondary cryogenic treatment was not performed after ageing treatment, and is identical with Embodiment 2 in other aspects.

### Comparative Example 3

The preparation method of a neodymium-iron-boron permanent magnet in Comparative Example 3 differs from the preparation method in Embodiment 8 in that primary cryogenic treatment was not performed after sintering of the green body and secondary cryogenic treatment was not performed after tempering treatment, and is identical with Embodiment 8 in other aspects.

The bending strength of the samarium-cobalt permanent magnets in Embodiments 1-7 and Comparative Examples 1-2 was tested, and 5 samples were used for the mechanical test in each state, the mean value was calculated, and the size, orientation and stress direction of the samples for the three-point bending test are shown in FIG. 1; the magnetic performance of the samarium-cobalt permanent magnets at room temperature in Embodiments 1-7 and Comparative Examples 1-2 was tested, and test results of the bending strength and magnetic performance are shown in Table 1.

TABLE 1
Bending strength and magnetic performance of
the samarium-cobalt permanent magnets in Embodiments
1-7 and Comparative Examples 1-2

| | Bending | Residual | | Magnetic energy |
|---|---|---|---|---|
| | strength | magnetism | Coercivity | product |
| Embodiments | MPa | Bᵣ/kGs | H_{cj}/kOe | (BH)ₘₐₓ/MGOe |
| Embodiment 1 | 157 | 10.99 | 30.96 | 29.52 |
| Embodiment 2 | 160 | 9.21 | 17.56 | 20.25 |
| Embodiment 3 | 153 | 10.89 | 29.86 | 29.26 |
| Embodiment 4 | 162 | 10.96 | 30.89 | 29.43 |
| Embodiment 5 | 159 | 11.05 | 30.76 | 29.63 |
| Embodiment 6 | 157 | 10.93 | 30.98 | 29.58 |
| Embodiment 7 | 143 | 10.98 | 29.89 | 29.47 |
| Comparative | 139 | 11.03 | 29.45 | 29.35 |
| Example 1 | | | | |
| Comparative | 134 | 9.25 | 17.14 | 20.01 |
| Example 2 | | | | |

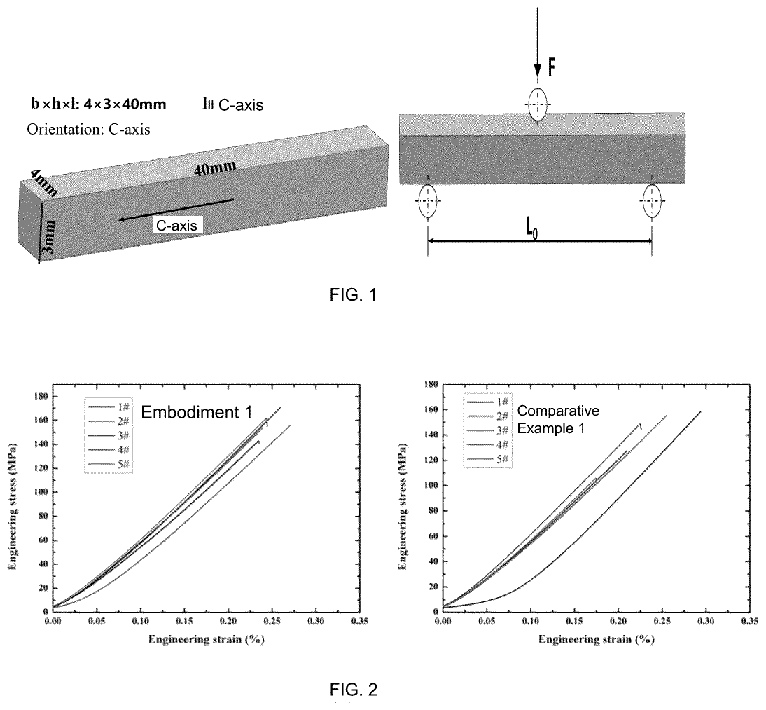

FIG. 2 illustrative three-point bending curves of the samarium-cobalt permanent magnet prepared in Embodiment 1 and the samarium-cobalt permanent magnet prepared in Comparative Example 1, and it can be seen, in conjunction with Table 1 and FIG. 2, that after the bending strength of the samarium-cobalt permanent magnet subjected to cryogenic treatment is improved compared with the samarium-cobalt permanent magnet not subjected to cryogenic treatment. It can be seen from Table 1 that the average bending strength of Embodiments 1-6 is greater than 150 MPa, and the average bending strength of Comparative Examples 1-2 is less than 140 MPa, indicating that after the samarium-cobalt permanent magnets in the invention are subjected to cryogenic treatment, the mechanical performance is greatly improved. Compared with the samarium-cobalt permanent magnet not subjected to cryogenic treatment in Comparative Example 1, the bending strength of the samarium-cobalt permanent magnets subjected to cryogenic treatment once in Embodiment 3 and Embodiment 7 is improved; compared with the samarium-cobalt permanent magnet subjected to cryogenic treatment once after sintering and solid solution in Embodiment 7, the samarium-cobalt permanent magnet subjected to cryogenic treatment once after aging treatment in Embodiment 3 shows better bending performance.

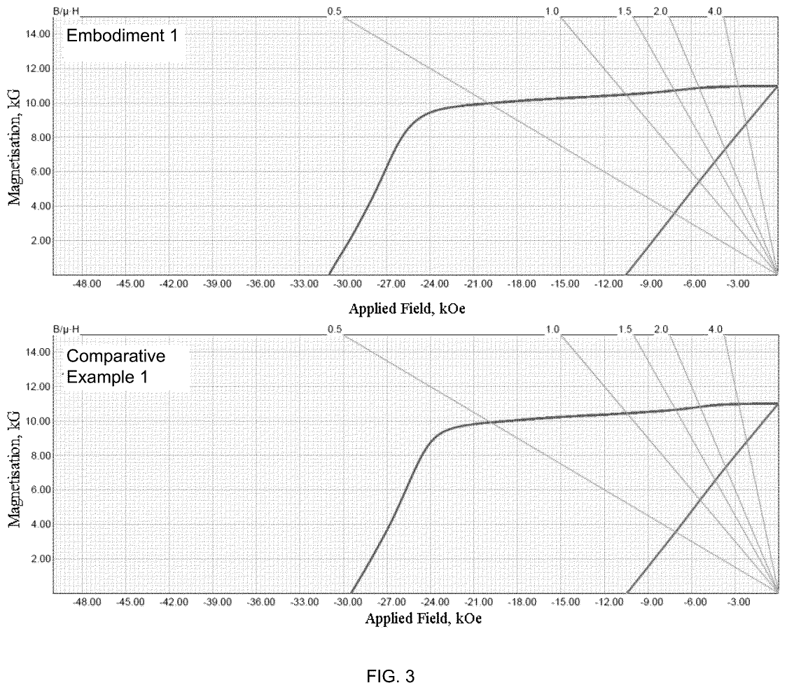

FIG. 3 illustrates demagnetization curves of the samarium-cobalt permanent magnet prepared in Embodiment 1 and the samarium-cobalt permanent magnet prepared in Comparative Example 1. It can be seen, in conjunction with Table 1 and FIG. 3, that compared with the samarium-cobalt permanent magnet not subjected to cryogenic treatment, the magnetic performance of the samarium-cobalt permanent magnet subjected to cryogenic treatment is slightly improved, indicating that the samarium-cobalt permanent magnet still has good magnetic performance after being subjected to cryogenic treatment. The magnetic performance of the samarium-cobalt permanent magnets subjected to cryogenic treatment once in Embodiment 3 and Embodiment 7 is relatively low.

The bending strength of the neodymium-iron-boron permanent magnet materials at room temperature in Embodiments 8-10 and Comparative Example 3 was tested, 5 samples were used for the mechanical test in each state, and a mean value was calculated; and the magnetic performance of the neodymium-iron-boron permanent magnet materials at room temperature in Embodiments 8-10 and Comparative Example 3 was tested, and test results of the bending strength and the magnetic performance are shown in Table 1.

TABLE 2
Bending strength and magnetic performance of the
neodymium-iron-boron permanent magnet materials
in Embodiments 8-10 and Comparative Example 3

| | Bending | Residual | | Magnetic energy |
|---|---|---|---|---|
| | strength | magnetism | Coercivity | product |
| Embodiments | MPa | Bᵣ/kGs | H_{cj}/kOe | (BH)ₘₐₓ/MGOe |
| Embodiment 8 | 322 | 13.62 | 18.15 | 44.51 |
| Embodiment 9 | 320 | 13.47 | 18.11 | 44.03 |
| Embodiment 10 | 317 | 13.59 | 18.14 | 44.39 |
| Comparative | 313 | 13.56 | 18.20 | 44.12 |
| Example 3 | | | | |

It can be seen from Table 2 that compared with the neodymium-iron-boron permanent magnet material not subjected to cryogenic treatment, the magnetic performance of the neodymium-iron-boron permanent magnet materials subjected to cryogenic treatment changes slightly, and the mechanical performance is improved.

All aspects, embodiments and features of the invention should be construed as illustrative, and are not used to limit the invention. The scope of the invention should be defined by the claims. Those skilled in the art can obtain other embodiments, amendments and uses without departing from the spirit and scope of the invention.

The steps of the preparation method in the invention are not limited to the order listed above, and changes to the order of the steps made by those ordinarily skilled in the art without creative labor should fall within the protection scope of the invention. In addition, two or more steps or actions may be performed at the same time.

Finally, it should be noted that the specific embodiments described in this specification are merely illustrative ones of the invention, and are not intended to limit the embodiments of the invention. Those skilled in the art can make various amendments or supplements or similar substitutions to the specific embodiments described in this specification, and it is impossible to exhaust all possible embodiments here. These changes or alterations derived from the essential spirit of the invention still fall within the protection scope of the invention, and it is against with the spirit of the invention to interpret them as any one additional limitation.

1. A preparation method of a rare earth permanent magnetic material, comprising one or more times of cryogenic treatment and tempering treatment.

2. The preparation method according to claim 1, wherein the preparation method comprises one time of cryogenic treatment and tempering treatment, and the cryogenic treatment is performed between sintering treatment and the tempering treatment, or the cryogenic treatment is performed after the tempering treatment.

3. The preparation method according to claim 1, wherein the preparation method comprises two or more times of cryogenic treatment and tempering treatment, at least one time of cryogenic treatment is performed between sintering treatment and the tempering treatment, and at least one time of cryogenic treatment is performed after the tempering treatment.

4. The preparation method according to claim 1, wherein the preparation method comprises two times of cryogenic treatment and tempering treatment, primary cryogenic treatment is performed after sintering treatment, then the tempering treatment is performed, and then, secondary cryogenic treatment is performed.

5. The preparation method according to claim 1, wherein the preparation method comprises three times of cryogenic treatment and tempering treatment.

6. The preparation method according to claim 5, wherein primary cryogenic treatment is performed after sintering treatment, then the tempering treatment is performed, then secondary cryogenic treatment is performed, and then, ternary cryogenic treatment is performed;
or, primary cryogenic treatment is performed after sintering treatment, then secondary cryogenic treatment is performed, then the tempering treatment is performed, and then, ternary cryogenic treatment is performed.

7. The preparation method according to claim 1, wherein the rare earth permanent magnetic material comprises one of an R₂Fe₁₄B series rare earth permanent magnetic material alloy, a SmCo₅ series rare earth permanent magnetic material alloy, a Sm₂Co₁₇ series rare earth permanent magnetic material alloy, a Sm₂Fe₁₇Nₓ series rare earth permanent magnetic material alloy, and a 1:12 type rare earth permanent magnetic material alloy.

8. The preparation method according to claim 2, wherein the preparation method comprises: raw material preparation, melting, pulverizing, oriented green compacting, the sintering treatment, the cryogenic treatment, and the tempering treatment;
or, the preparation method comprises: raw material preparation, melting, pulverizing, oriented green compacting, the sintering treatment, the tempering treatment, and the cryogenic treatment.

9. The preparation method according to claim 4, wherein the preparation method comprises: raw material preparation, melting, pulverizing, oriented green compacting, the sintering treatment, the primary cryogenic treatment, the tempering treatment, and the secondary cryogenic treatment.

10. The preparation method according to claim 5, wherein the preparation method comprises: raw material preparation, melting, pulverizing, oriented green compacting, sintering treatment, primary cryogenic treatment, the tempering treatment, secondary cryogenic treatment, and ternary cryogenic treatment;
or, the preparation method comprises: raw material preparation, melting, pulverizing, oriented green compacting, sintering treatment, primary cryogenic treatment, secondary cryogenic treatment, the tempering treatment, and ternary cryogenic treatment.

11. The preparation method according to claim 1, wherein the step of cryogenic treatment comprises: placing a green body in a cryogenic treatment system, performing cryogenic treatment when the temperature is decreased to a cryogenic treatment temperature, and then taking the green body out of the cryogenic treatment system;
or, the step of cryogenic treatment comprises: directly placing a green body in liquid nitrogen for cryogenic treatment, and then taking the green body out of the liquid nitrogen.

12. The preparation method according to claim 1, wherein a cryogenic treatment temperature is lower than or equal to −130° C., and/or a cryogenic treatment time is 1-500 min.

13. The preparation method according to claim 1, wherein a cryogenic treatment temperature is lower than or equal to −160° C., and/or a cryogenic treatment time is 10-400 min.

14. The preparation method according to claim 1, wherein a cryogenic treatment temperature is lower than or equal to −190° C., and/or a cryogenic treatment time is 20-300 min.

15. The preparation method according to claim 1, wherein the tempering treatment is one of tempering diffusion treatment, aging treatment and nitrogen treatment.

16. The preparation method according to claim 15, wherein the tempering diffusion treatment comprises: performing primary tempering at 800-950° C. for 2-6 h, and then decreasing the temperature to 400-650° C. at a rate of 0.3-1.3° C./min to perform secondary tempering for 2-6 h;
the aging treatment comprises: maintaining the green body at 800-950° C. for 10-25 h, then decreasing the temperature to 400-550° C. at a rate of 0.3-1.3° C./min, and maintaining the green body at 400-550° C. for 2-12 h;
the nitrogen treatment comprises: maintaining the green body at 400-650° C. for 1-20 h under a nitrogen and/or ammonia atmosphere.

17. A rare earth permanent magnetic material, being prepared by the preparation method for a rare earth permanent magnetic material according to claim 1.
